(19) United States
(12) Patent Application Publication
(10) Pub. No.: US 2016/0113312 A1
(43) Pub. Date: Apr. 28, 2016

(54) PROCESSED BROWN RICE, FERMENTED FOOD, AND METHOD FOR MANUFACTURING PROCESSED BROWN RICE

(71) Applicant: KADOMASAYA, INC., Wakayama (JP)

(72) Inventor: Tadashi INOUE, Wakayama (JP)

(73) Assignee: KADOMASAYA, INC., Wakayama (JP)

(21) Appl. No.: 14/892,283

(22) PCT Filed: Aug. 22, 2014
(86) PCT No.: PCT/JP2014/072069

§ 371 Date: Nov. 19, 2015

(30) Foreign Application Priority Data
Aug. 23, 2013 (JP) 2013-172754
Mar. 31, 2014 (JP) 2014-070692

(51) Int. Cl. A23L 1/182; A21D 8/04; C12G 3/02; A23L 1/025; A21D 13/04

(52) U.S. Cl. CPC A23L 1/182; A23L 1/025; A21D 13/04; C12G 3/02; A21D 8/04; A23V 2002/00

(57) ABSTRACT

A method to provide processed brown rice, in which the content of free ferulic acid that contributes to the amelioration of dementia, can be increased. High water pressure-treated processed brown rice characterized by being obtained by applying hydrostatic pressure of 100 MPa to 600 MPa to brown rice in water at 0 degrees C. to 35 degrees C. to thereby increase the content of free ferulic acid in the brown rice, and drying the brown rice immediately after the application of the hydrostatic pressure. Fermented food such as bread, sake or sake lees that are manufactured by using the processed brown rice as raw material, characterized in that the content of free ferulic acid in the fermented food has been increased by fermenting the processed brown rice with using yeast or by pregelatinizing the processed brown rice and then fermenting the same with using yeast.

### CROSS REFERENCE TO RELATED APPLICATIONS

This application claims priority to Japanese Patent Application No. 2013-172754 filed on Aug. 23, 2013, the entire contents of which are incorporated by reference herein. This application is a U.S. nationalization under 35 U.S.C. .sctn.371 of International Application No. PCT/JP2014/072069, filed Aug. 22, 2014. The disclosure set forth in the referenced application is incorporated herein by reference in its entirety.

### TECHNICAL FIELD

The present invention relates to processed brown rice, fermented food, and a method for manufacturing processed brown rice.

### BACKGROUND ART

Conventionally, techniques to more easily eat brown rice by applying pressure exist a lot. For examples, Patent Literature 1, Patent Literature 2, Patent Literature 3, Patent Literature 4, Patent Literature 5, Patent Literature 6, and Patent Literature 7 disclose the technique to easily eat the brown rice by applying a pressure processing and a heat processing to brown rice in water.

In addition, brown rice originally contains many kinds of enzymes such as the glutaminic acid decarboxylase (GAD), and these enzymes activate by the brown rice absorbing water. For examples, Patent Literature 8, Patent Literature 9, Nonpatent Literature 1, Nonpatent Literature 2, and Nonpatent Literature 3 disclose the technique to increase γ-aminobutyric acid (GABA) with enzyme activity (water activity) such as GAD in the brown rice by applying a high pressure processing to brown rice in water, closing the moisture content in the brown rice to the saturation moisture content (e.g., 32%), and being left in this state for predetermined time.

### PRIOR ART DOCUMENTS

### Patent Literature

Patent Literature 1: Japanese Examined Patent Publication No. 6-7777

Patent Literature 2: Japanese Unexamined Patent Application Publication No. 9-299048

Patent Literature 3: Japanese Unexamined Patent Application Publication No. 2005-156

Patent Literature 4: Japanese Unexamined Patent Application Publication No. 2008-167730

Patent Literature 5: Japanese Unexamined Patent Application Publication No. 2009-106183

Patent Literature 6: Japanese Unexamined Patent Application Publication No. 2012-34621

Patent Literature 7: Japanese Unexamined Patent Application Publication No. 2001-292713

Patent Literature 8: Japanese Unexamined Patent Application Publication No. 2005-117982

Patent Literature 9: Japanese Unexamined Patent Application Publication No. 2010-063454

### Nonpatent Literature

Nonpatent Literature 1: Japan Food Science Engineering Bulletin, 1999, vol.46, No.5, p.323-328

Nonpatent Literature 2: Japan Journal of Food Engineering, 2010, vol.11, No.4, p.189-199

Nonpatent Literature 3: Iijima Memory Food Science Promotion Foundation 2008 annual report, 2010, p.201-206

### SUMMARY OF INVENTION

### Problems to Be Solved by the Invention

By the way, brown rice is in condition of being removed chaff from unhulled rice of fructi-rice, and is comprised of bran layer (rind of fruit, seed coat, aleurone layer) of the outer layer, the endosperm of the inner layer, and an embryo. If the bran layer is removed from the brown rice, the brown rice becomes the rice with embryo which is comprised of the endosperm and the embryo, and if the rice with embryo is removed from the embryo, the polished rice (milled rice) is produced. The endosperm in the polished rice includes approximately 70% of starch (carbohydrates), and the starch of the endosperm becomes pastiness (gelatinize) by boiling the polished rice at ordinary pressure. The brown rice includes the bran layer and the embryo in comparison with the polished rice so that the brown rice can include the nutrient which human being needs in a good balance and the brown rice can include dietary fiber, vitamin B family, vitamin E family, and the like in richness in particular. The bran layer of the brown rice is generally comprised of cell membranes of polysaccharides of arabino xylan, and free ferulic acid (polyphenolic one kind, 4-oxy3-methoxycinnamic acid, C₁₀H₁₀O₄, ferulic acid) is bond to the polysaccharides of arabino xylan (bonded ferulic acid is call bound ferulic acid).

The free ferulic acid is composed mainly of γ-oryzanol (ester of free ferulic acid and alcohol), the antioxidant power of the free ferulic acid is usually superior to antioxidant power of γ-oryzanol, and the free ferulic acid is known to have the improvement and the prevention of the dementia, the effect of the anticancer action, or the like. For example, it is reported in Japan Geriatrics Society that if an Alzheimer's dementia patient continues to take free ferulic acid purified form rice bran the cognitive function of the patient was improved. In addition, it is reported in American Cancer Society that free ferulic acid lets internal natural killer cell activate and exhibits anticancer action. Furthermore, free ferulic acid strongly suppresses the oxidation of fat, and the antioxidant of free ferulic acid is hardly lost by heating. Therefore, the free ferulic acid provides the improvement of autonomic imbalance (gastric ulcer), brain function improving effect (increase quantity of glucose uptake in the brain), blood platelet coagulation-inhibiting action, or the like. Furthermore, it is said that the free ferulic acid extremely has higher absorption efficiency and availability to the body in comparison with the bound ferulic acid and other polyphenol, and shows the antioxidant action in the body even if a little.

The bran layer of brown rice contains the bound ferulic acid and almost none of the free ferulic acid (below the detection limit). Even if the bran layer of the brown rice enters the body, the bran layer is discharged in the outside of the body without cutting the bound ferulic acid as the free ferulic acid. Because the bound ferulic acid presenting around cell walls of the bran layer is bound to fiber components of lignin and the cellulose, it is hard to absorb the bound ferulic acid from the intestinal tract. In addition, although the bound ferulic acid may become the free ferulic acid by intestinal bacteria, the bound ferulic acid is metabolized to a small molecule more by the intestinal bacteria, and the bound ferulic acid is not absorbed as the free ferulic acid in the body after all. Therefore, conventionally, there is a problem that the free ferulic acid included in the brown rice originally cannot be effectively utilized.

Conventionally, there is a heat processing and a high hydrostatic pressure processing as a processing of the addition to food. The heat processing is a simple and easy method, but there are problems that by adding heat to food the bad smell generates from the food components, the food components are deteriorated, the abnormal material generates, or the like. The high hydrostatic pressure processing that the hydrostatic pressure is more than 100 MPa (super high water pressure treatment) is known to cause the generation or the destruction of relatively weak bonds for the food components without the problems of the heat processing.

Accordingly, the present invention was created as a solution for the problems and aims at providing processed brown rice, fermented food, and a method for manufacturing processed brown rice, which can increase the content of free ferulic acid contributing to the amelioration of dementia, and the like.

### Solution to Problem

After conducting rigorous and repeated research, the present inventors have completed novel processed brown rice, novel fermented food, and a novel method for manufacturing processed brown rice in accordance with the present invention. Namely, the present invention comprises high hydrostatic pressure-applied processed brown rice, the processed brown rice being obtained by applying hydrostatic pressure of 100 MPa to 600 MPa to brown rice in water at 0.degree. C. to 35.degree. C. to thereby increase the content of free ferulic acid in the brown rice, and drying the brown rice immediately after the application of the hydrostatic pressure.

Also, the present invention comprises fermented food such as bread, sake or sake lees that is manufactured by using the processed brown rice as raw material, the processed brown rice being obtained by applying hydrostatic pressure of 100 MPa to 600 MPa to brown rice in water at 0.degree. C. to 35.degree. C. to thereby increase the content of free ferulic acid in the brown rice, and drying the brown rice after the application of the hydrostatic pressure. The fermented food of the present invention increases the content of free ferulic acid in the fermented food by fermenting the processed brown rice with using yeast or by pregelatinizing the processed brown rice and then fermenting the same with using yeast.

Also, the present invention comprises a method for manufacturing high hydrostatic pressure-applied processed brown rice, and the method comprises a step of putting brown rice in water at 0.degree. C. to 35.degree. C., a step of applying hydrostatic pressure of 100 MPa to 600 MPa to the brown rice to thereby increase the content of free ferulic acid in the brown rice, and a step of drying the brown rice immediately after the application of the hydrostatic pressure.

### Advantageous Effects of Invention

According to the present invention, processed brown rice, fermented food, and a method for manufacturing processed brown rice can increase the content of free ferulic acid contributing to the amelioration of dementia, and the like.

### BRIEF DESCRIPTION OF DRAWINGS

FIG. 1A is a photograph indicating an example of a manufacturing apparatus of processed brown rice in accordance with an embodiment of the present invention.

FIG. 1B is an illustration indicating an example of a manufacturing apparatus of processed brown rice in accordance with an embodiment of the present invention.

FIG. 2A is a photograph indicating a state that brown rice and water are put into a pressure-receiving part.

FIG. 2B is a photograph indicating a state that a piston part is moving to the pressure-receiving part.

FIG. 2C is a photograph indicating a state that one end of the piston part fits into the opening part of the pressure-receiving part.

FIG. 2D is a photograph indicating a state that a super high hydrostatic pressure application is applied to other end of the piston part.

FIG. 3A is a photograph indicating brown rice before the pressurization.

FIG. 3B is a photograph indicating processed brown rice after the pressurization.

FIG. 4 is an example of a graph indicating a relationship between hydrostatic pressure applied to brown rice and the content of free ferulic acid in the brown rice.

FIG. 5A is a photograph indicating bread by using the processed brown rice as raw material.

FIG. 5B is a photograph indicating bagel by using the processed brown rice as raw material.

FIG. 5C is a photograph indicating panettone by using the processed brown rice as raw material.

FIG. 5D is a photograph indicating stollen by using the processed brown rice as raw material.

FIG. 6 is a photograph indicating sake manufactured by using the processed brown rice of in accordance with an embodiment of the present invention as steamed rice.

### DETAILED DESCRIPTION

The preferred embodiments of processed brown rice, fermented food, and a method for manufacturing processed brown rice in the present invention will be explained below according to the attached drawings; thereby the present invention will be clearly understood. The embodiments below are examples materializing the present invention, and do not limit the technical scope of the present invention.

<processed brown rice>

Conventionally, there was almost none of free ferulic acid in brown rice, and the detailed study was not done about a relation between the brown rice and the content of free ferulic acid. In addition, there are the techniques to increase total ferulic acid including all bound ferulic acid by decomposing polysaccharides of arabino xylan of the bran layer with activation of enzymes of the brown rice. The activation of enzymes needs to maintain the state that the moisture content of the brown rice raises, thereby the brown rice rotten, sundry germs propagate, and it is impossible to commercialize the brown rice. This inventor studies brown rice applied high hydrostatic pressure for many years, and this inventor thought that it is possible to destroy plant cell walls of the bran layer in the brown rice instantly with using super high hydrostatic pressure processing and without using both the heat processing and the enzyme activity, and to cut bound ferulic acid weakly combined with polysaccharides of arabino xylan of the bran layer in the brown rice. And this inventor completed this invention based on the examples.

Namely, the present invention comprises high hydrostatic pressure-applied processed brown rice, the processed brown rice being obtained by applying hydrostatic pressure of 100 MPa (1000 atm) to 600 MPa (6000 atm) to brown rice in water at 0. degree. C.-35. degree. C. to thereby increase the content of free ferulic acid in the brown rice, and drying the brown rice immediately after the application of the hydrostatic pressure. By cutting the bound ferulic acid weakly combined with polysaccharides of arabino xylan of the bran layer in the brown rice based on the high hydrostatic pressure, it is possible to markedly increase (generate) the content of free ferulic acid in the processed brown rice in comparison with the content of free ferulic acid in normal brown rice. When user eats the processed brown rice of the present invention, it is possible to easily take the free ferulic acid which was not utilized enough so far, and to expect the improvement and the prevention of the dementia, the effect of the anticancer action, and the like.

Here, the brown rice used in the present invention is not limited in particular if being normal brown rice. For example, the brown rice includes brown rice before the germination, the brown rice after the germination, unpolished nonglutinous rice and unpolished glutinous rice. In addition, the form of the brown rice is not limited in particular. The form includes crushed material or powder of the brown rice. The kind of water to be put brown rice in is not limited in particular. For example, the water includes fresh water, normal drinking water, and nourishment water be added a nutrient in. When the brown rice is applied high hydrostatic pressure after the brown rice is put in the nourishment water, it is possible to infiltrate the nutrient into the inside of the brown rice forcibly, and to raise nutritive value of the processed brown rice more.

Here, the hydrostatic pressure is not limited in particular if being in the range of 100 MPa to 600 MPa. Therefore, even if there is not a large-scale manufacturing apparatus (pressure-applying apparatus), it is possible to increase the content of free ferulic acid. In the water immersion applied super high hydrostatic pressure of more than 100 MPa, germination restraint action and activity of the enzyme decrease, and the enzyme (e.g., GAD) of the brown rice does not work. For example, hydrolase (e.g., α-amylase) in the brown rice deactivates under the super high hydrostatic pressure. Therefore, it is possible to increase (generate) the content of free ferulic acid in the brown rice in the water immersion applied super high hydrostatic pressure to the brown rice without increasing the content of total ferulic acid of the brown rice. And, under the super high hydrostatic pressure (e.g., 600 MPa), the bacteria become the 0/unit, the common bacteria become 0/g to 300/g, it is hard to occur the propagation of sundry bacteria and the degradation of the quality, and it is superior in safety.

The water temperature to apply the hydrostatic pressure to the brown rice is not limited in particular if being in 0.degree. C. to 35.degree. C. Therefore, it is possible to prevent thermal denaturation of the brown rice by the super high hydrostatic pressure processing surely, and to increase the content of free ferulic acid in the brown rice conspicuously. If the water temperature exceeds 40 .degrees. C., it is in condition of having been cooked the brown rice with heat (the expansion of the starch grain of the brown rice is started), and the hydrostatic pressure may not contribute to cutting of the bound ferulic acid. For example, the enzyme of the brown rice is more activated by heat processing at temperature such as 40 .degrees. C., but around 10̂6/g of various germs originally exist in the brown rice, the brown rice in the water immersion of 40 .degrees. C. cannot be product by the propagation of sundry bacteria. The present invention uses the super high hydrostatic pressure processing without using both the heat processing and the enzyme activity, the range of the above-mentioned water temperature is preferable.

The pressurization time to apply the hydrostatic pressure to the brown rice is not limited in particular if reaching the hydrostatic pressure of the aim. For example, if the hydrostatic pressure of the aim is set 600 MPa, when the hydrostatic pressure applied to the brown rice reaches 600 MPa form ordinary pressure, the pressurization time is set to an instant (around one second), and the hydrostatic pressure is released immediately. If the pressurization time is set to predetermined time (from several seconds to several minutes), the hydrostatic pressure of the aim may be continued to apply to the brown rice. For example, the pressurization time is in the range of 1 second to 30 seconds, the range of 1 second to 1 minute, or the range of 1 second to 10 minutes. After reaching the hydrostatic pressure of the aim, the applied hydrostatic pressure may be repeat that the applied hydrostatic pressure is depressurized to the range of 80% to 95% of the hydrostatic pressure of the aim and pressurized to the hydrostatic pressure of the aim in the pressurization time. Considering productivity, if the pressurization time is set to an instant, when the hydrostatic pressure applied to the brown rice reaches the hydrostatic pressure of the aim, the applied hydrostatic pressure is released immediately preferably.

The pressurization speed to pressurize from ordinary pressure to the hydrostatic pressure of the aim and the depressurize speed to depressurize from the reached hydrostatic pressure to ordinary pressure are not the limitation in particular. Here, the pressurization speed and the depressurize speed are designed depending on the constitution of a manufacturing apparatus, and are in the range of 3 M Pa/sec to 200 MPa/sec for example.

In addition, the preprocessing before applying to the brown rice is not limited in particular. For example, if the preprocessing is done, it is preferable to immerse brown rice before the pressurization in water at predetermined time. Therefore, by softening the brown rice in water (drinking water or nourishment water) to some extent, it is easy to cut the bound ferulic acid by the hydrostatic pressure. In addition, from a point of the productivity, without the preprocessing, when being put in water, the brown rice may be applied immediately.

The content of free ferulic acid in the processed brown rice is not limited in particular if being increased in comparison with the content (0.0 mg/kg, below the detection limit) of normal brown rice. The content of normal brown rice is below 0.5 mg/kg of the detection limit, and may be thought approximately 0 mg/kg. For example, the content of free ferulic acid in the processed brown rice is more than 3.0 mg/kg preferably, and more than 8.0 mg/kg more preferably. Therefore, it is possible to increase intakes of free ferulic acid, and to expect the improvement and the prevention of the dementia, and the effect of the anticancer action.

The content (mg/kg) of free ferulic acid is obtained by eluting water-soluble free ferulic acid with predetermined solvent (e.g., methanol) from brown rice, analyzing the solvent including the free ferulic acid with using a high performance liquid chromatography, and converting into the analyzed weight (mg) of free ferulic acid per unit weight (kg) of the brown rice. The content (mg/kg) of total free ferulic acid is obtained by processing alkali treatment to brown rice as pre-processing, by analyzing the free ferulic acid hydrolyzed by the alkali treatment with using a high performance liquid chromatography, and by converting into the analyzed weight (mg) of free ferulic acid per unit weight (kg) of the brown rice. Therefore, the content of the free ferulic acid means the content of ferulic acid caused by isolating of bound ferulic acid combined with the polysaccharides of arabino xylan of the bran layer weakly. The content of total ferulic acid means the content of ferulic acid caused by forced peeling of all bound ferulic acid (include weaky combining bound ferulic acid and strongly combining bound ferulic acid) from the polysaccharides of arabino xylan. So, the content of the free ferulic acid is completely different from the content of total ferulic acid.

The brown rice after applying the hydraulic pressure is dried immediately. Here, the moisture content of the processed brown rice after applying the super high hydrostatic pressure is high, so the brown rice may rot when the later processed brown rice is immerse in water in itself. Therefore, the later processed brown rice is dried immediately. The drying of the brown rice means that the moisture content of the brown rice is lowered to approximately 15% with using drying apparatus, and the processed brown rice is applied the ordinary pressure drying or depressurization processing at normal temperature or a high temperature immediately. The present invention is aimed for increase and generation of the content of free ferulic acid, and is not aimed for enzyme activity. If the moisture content is not high enough (saturated moisture content, more than 30%), the enzyme of brown rice is not activated. Therefore, the enzyme of brown rice cannot be activated for drastically reducing the moisture content of the processed brown rice when the processed brown rice is dried immediately.

<fermented food using the processed brown rice as raw material>

The usage of the processed brown rice in the present invention is not limited in particular. For example, the processed brown rice may be ate after boiling the processed brown rice only or the processed brown rice mixed with polished rice at ordinary pressure, or may be used as raw material (starting material) of food. For example, the food includes bread, sake, sake lees, chocolate, sherbet, rice confectionery such as rice cracker, noodles such as rice noodles, or the like. When the processed brown rice is used as raw material, the usage is not limited in particular. For example, the processed brown rice may be used (added) as it is, or the crushed material or the powder of the processed brown rice may be used.

It is preferable to use the processed brown rice as raw material of fermented food, the fermented food being obtained by fermenting the processed brown rice with using yeast. Namely, the present invention is fermented food manufactured by using the processed brown rice as raw material, the processed brown rice being obtained by applying hydrostatic pressure of 100 MPa to 600 MPa to brown rice in water at 0.degree. C. to 35.degree. C. to thereby increase the content of free ferulic acid in the brown rice, and drying the brown rice after the application of the hydrostatic pressure. The brown rice after the application of the hydrostatic pressure is used as the material of fermented food, so may not dry immediately. The present invention increases the content of free ferulic acid in the fermented food by fermenting the processed brown rice with using yeast or by pregelatinizing the processed brown rice and then fermenting the same with using yeast. Therefore, it is possible to promote the cutting of the bound ferulic acid of the polysaccharides of arabino xylan in the processed brown rice, and to increase the content of free ferulic acid by providing the fermentation processing for raw materials of the processed brown rice.

The pregelatinizing means that starch (brown rice or polished rice) is gelatinized by a method of the adding water and the heating, and the pregelatinizing in the present invention means that a gelatinization degree of the processed brown rice becomes 100% or is close to 100%. For example, the method of pregelatinizing can be applied a method of boiling, steaming, or merely heating to the processed brown rice. If the gelatinization degree of the processed brown rice is high, so the processed brown rice can be fermented. If the processed brown rice is pregelatinized, it is easy to ferment the processed brown rice preferably. The fermentation means that yeast feeds the processed brown rice boiled or steamed as raw materials (energy) under anaerobic condition, oxidizes and decomposes the organic compound in the processed brown rice, and produces products such as alcohol, organic acid, carbon dioxide, and the like.

The yeast is not limited in particular if having fermentation action, for example, the yeast may be only one kind of yeast, or the combination of yeast of plural kinds. The yeast may be made in combination with fermentation bacteria such as malted rice, lactic acid bacterium, methane bacteria, or the like. The yeast may be made in combination with enzymes such as cell membrane degrading enzyme, cellulose and hemicellulose degrading enzyme, pectic degrading enzyme, protein degrading enzyme, carbohydrate degrading enzyme, peptide degrading enzyme, and the like. The condition of the fermentation is not limited in particular if being promoted the oxidation decomposition of the processed brown rice by the yeast. For example, the condition of the fermentation is 1 day to several months at 20.degree. C. to 50.degree. C.

The present invention may be provided other processing before or after the fermentation depending on a kind of the fermented food. Specifically, when the fermented food is bread, it is possible to provide post-fermentation processing (second fermentation processing) fermenting the fermentation product by the yeast after the fermentation processing (primary fermentation processing) of the processed brown rice boiled. When the fermented food is sake or sake lees, it is possible to provide pre-fermentation processing to ferment the steamed processed brown rice by malted rice before the fermentation processing.

The fermented food is not limited in particular. Typically the fermented food includes bread, sake, sake lees, beer, or the like. When the fermented food is bread, the content of free ferulic acid in the bread is increased in comparison with the content (0 mg/kg) of free ferulic acid in normal bread manufactured by using normal wheat flour, normal polished rice, or normal brown rice. It may be thought that the content of free ferulic acid in normal bread manufactured by using normal brown rice is approximately 0 mg/kg.

The manufacturing method of the bread is not limited in particular if including a processing to ferment by yeast after boiling the processed brown rice (after pregelatinizing). For example, a delicious bread of the present invention is produced by adding hard flour, water, milk, sugar, salt, yeast (yeast fungus), and butter to the boiled processed brown rice appropriately, mixing the added thing, primary-fermenting and second-fermenting, making bread dough, and burning with an oven. It is preferable to mix the processed brown rice and small red beans (adzuki bean), to boil red brown rice (brown rice boiled together with red beans), and to manufacture bread by using the red brown rice as raw materials with the above-mentioned method. The affinity between brown rice and red beans is good, and the red beans include vitamin B1 in large quantities, the vitamin B1 contributing to the digestion resolution of the starch. Therefore, it is possible to take in nutrients such as free ferulic acid, vitamin B1 in a good balance when eat the bread based on the red brown rice obtained by boiling the processed brown rice and small red beans.

The kind of the bread in the present invention is not limited in particular, for example, the bread includes sliced bread, sweet baked goods, sponge bread, bagel, panettone, stollen, doughnuts, French bread, hardtack, rusk, or the like. It is preferable to add high nutritive additives such as black sesame, millet sugar, raisin soaked in rum, sweet potato roast square-cutted, mushroom boiled down in soy sauce, or the like.

When the bagel is manufactured, for example, a delicious bagel is produced by adding powdered tea and red beans boiled in thick soy with sugar, or fried onion to the processed brown rice. When the panettone is manufactured, a delicious panettone is produced by fermenting bread dough with the yeast of the panettone, by adding dried fruit such as raisin soaked in rum, pebbling orange peel, or the like to the bread dough, by baking the bread dough, and by covering sugar on the surface of the baking product. When the stollen is manufactured, a delicious panettone is produced by adding dried fruit or nuts to bread dough made powder of the processed brown rice and well-known raw materials.

When the fermented food is sake manufactured by using the processed brown rice as steamed rice, the content of free ferulic acid in the sake is increased in comparison with the content (0.0 mg/kg, below the detection limit) of normal brown rice sake manufactured by using normal brown rice. The content of free ferulic acid in normal brown rice sake may be thought approximately 0 mg/kg. For example, the content of free ferulic acid in the sake in the present invention is more than 5.0 mg/kg preferably, and more than 16.0 mg/kg more preferably. Therefore, it is possible to intake a large quantity of free ferulic acid easily by drinking the sake.

The alcohol concentration in the sake in the present invention is not limited in particular if fluctuating depending on a manufacturing method. The alcohol concentration in the sake in the present invention is increased in comparison with the alcohol concentration in the sake manufactured by using normal brown rice, and is more than 16 degrees. Therefore, by applying super high hydrostatic pressure to the processed brown rice in advance, the yeast invades plant cell walls of the bran layer applied and collapsed in fermentation processing easily, the yeast acts with starch easily, the fermentation processing promotes, and the alcohol concentration is increased. In this case, it is possible to sell the sake in the present invention as low alcohol sake, the sake diluted with water or soda, or to sell only the alcohol extracted excessive alcohol by well-known techniques. The alcohol concentration means the content (v/v %) of the alcohol in the sake manufactured, and it is possible to measure by well-known measurement methods such as a vibratory densimeter, a commercial alcohol measuring equipment, a gas chromatography, or the like. The usage of the sake is not limited in particular. For example, it is possible to use the sake as healthy sake being easy to intake free ferulic acid, and to use mixture with the well-known sake as new sake.

When the fermented food is sake lees obtained by manufacturing sake with using the processed brown rice as steamed rice, the content of free ferulic acid in the sake lees is increased in comparison with the content (example, 1.6 mg/kg) of free ferulic acid in normal sake lees obtained by manufacturing normal sake. For example, the content of free ferulic acid in the sake lees is more than 30.0 mg/kg preferably, and more than 60.0 mg/kg more preferably. Therefore, it is possible to intake a large quantity of free ferulic acid easily.

The usage of the sake lees is not limited in particular. For example, the sake lees may be used as health assistance constituent such as food, supplement, pharmaceutical product, or the like, that obtained by powdering the sake lees dried, or by mixing the powder with well-known carrier permitted pharmaceutically, excipient, diluent, bulking agent, binder, lubricant, flow assistant, disintegrating agent, surfactant, conventional additive, or the like. The health assistance constituent may be used as it is or be processed, and may be concentrated or diluted, provided by dry processing such as freeze drying, heating drying. The form of the healthy supporting constituent includes the solids such as solution, suspension, paste-formed semisolid, powder, the granule, or the like. When the sake lees are powder, the powder may be used by dissolving the powder in water.

The manufacturing method of the sake or the sake lees in the present invention is not limited in particular if including a processing to ferment the steamed rice by yeast after boiling the processed brown rice (pregelatinizing the processed brown rice). For example, it is done as the following. First, the steamed rice is made by boiling the processed brown rice, malted rice is made by adding Aspergillus oryzae (e.g., seed malt) to the steamed rice (the step koji production). In the step koji production, the malted rice is produced by leaving the steamed rice sprinkled the spore of the yellow Aspergillus oryzae called the seed malt in large quantities for approximately two days after cooling the steamed rice to predetermined temperature. Next, maturing yeast mash cultured in large quantities is produced by leaving the yeast mash for two weeks, the yeast mash produced by adding malted rice produced, water, and yeast (bacteria) to new steamed rice (sake mash-making). The mash is produced by adding new steamed rice, malted rice, and water to yeast mash produced (sake brewing preparation). The malted rice converts starch of the steamed rice into glucose by the sake brewing preparation, and the yeast converts glucose into alcohol (parallel double fermentation). The production of the mash is usually divided into three times (three steps of sake brewing preparation, three steps of hatsuzoe, nakazoe, and tomezoe), and the quantity of the overall mash is increased by increasing the number of steps. When the third step of the sake brewing preparation is finished, maturational period (approximately 20 days) is provided while being managed the temperature. The mash passed the maturational period is squeezed by a predetermined squeezer, and is separated by sake and sake lees. The separated sake is provided as raw sake, pure sake reduced alcohol concentration, or raw sake heat-treated. The separated sake lees (tabular) are a board-formed, is provided as it is, or a preserved food obtained by putting the sake lees and vegetables in a tank. The sake is manufactured by three steps of the step koji production, sake mash-making, sake brewing preparation, and the manufacturing method of the sake is not limited in particular. For example, the sake may be manufactured by two steps of the step koji production and sake mash-making without sake brewing preparation, or be used by a well-known manufacturing method. Malted rice is used in the step koji production, or enzyme agent may be used in place of malted rice.

A normal manufacturing method of normal sake or normal sake lees is by entering brown rice to rice-polishing machine, by becoming the polished rice to cut the approximately 30% of the outer layer of the brown rice, and by boiling the polished rice as steamed rice. So the normal manufacturing method needs milled rice processing. In the present invention, the processed brown rice has already had high gelatinization degree, and a normal milled rice processing is unnecessary. Therefore, it is possible to use all 100% of the processed brown rice and to provide excellent cost performance by reducing the normal milled rice processing.

<method for manufacturing the processed brown rice>

Then, a method for manufacturing the processed brown rice in the present invention is explained. At first, the method for manufacturing high hydrostatic pressure-applied processed brown rice comprises a step of putting brown rice in water at 0.degree. C. to 35.degree. C., a step of applying hydrostatic pressure of 100 MPa to 600 MPa to the brown rice to thereby increase the content of free ferulic acid in the brown rice, and a step of drying the brown rice immediately after the application of the hydrostatic pressure. The method may include a step of increasing the content of free ferulic acid in the fermented food by fermenting the processed brown rice with using yeast or by pregelatinizing the processed brown rice and then fermenting the same with using yeast.

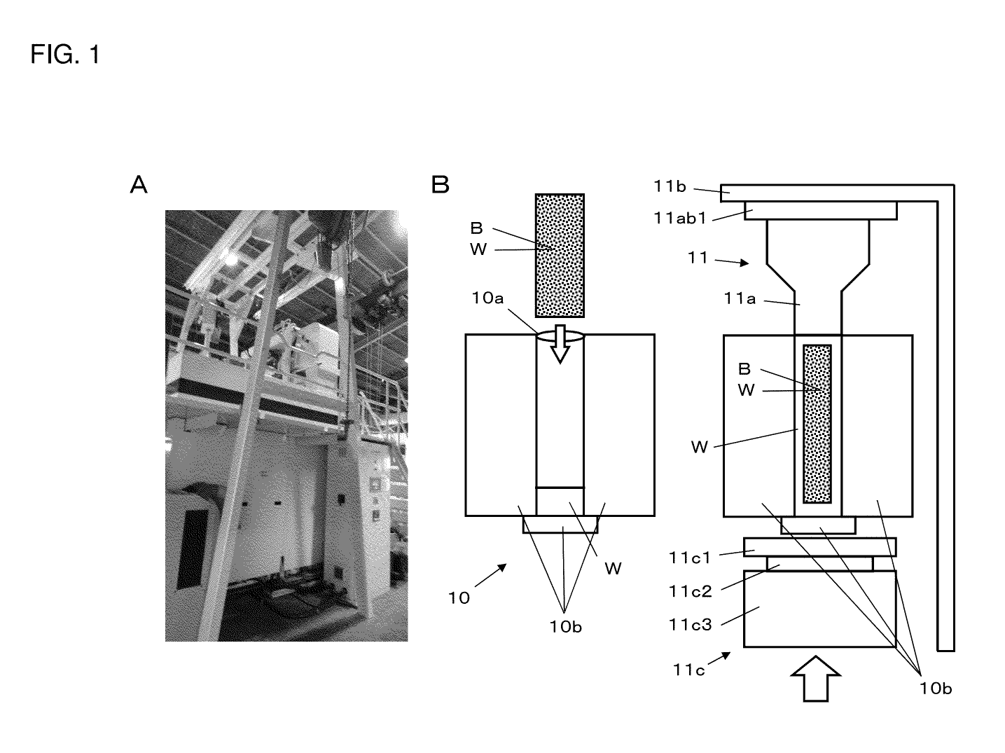

The method for manufacturing the processed brown rice is carried out by a manufacturing apparatus 1. As shown FIG. 1A, FIG. 1B, the manufacturing apparatus 1 carrying out the method includes a pressure-receiving part 10 in pressure resistance, a pressurizing part 11, a drying part (not illustrated). The pressure-receiving part 10 is for putting brown rice in water at 0.degree. C. to 35.degree. C., the pressurizing part 11 is for applying hydrostatic pressure of 100 MPa to 600 MPa to the brown rice to thereby increase the content of free ferulic acid in the brown rice, and the drying part is for drying the brown rice immediately after the application of the hydrostatic pressure.

The pressure-receiving part 10 is not limited in particular if being able to endure the hydrostatic pressure of the pressurizing part 11. For example, the pressure-receiving part 10 includes an opening part 10a, and a housing part 10b. The opening part 10a is arranged on the surface of the pressure-receiving part 10 for entering brown rice and water. The housing part 10b is arranged on the side face and the bottom face of the pressure-receiving part 10, and is constituted by pressure tightness. The shape of the inside of the pressure-receiving part 10 (the housing part 10b) is not limited in particular if including a cylindrical shape, a triangle pole shape, a square pole shape, a polygonal shape, or the like. The shape of the inside of the pressure-receiving part 10 is a cylindrical shape in the manufacturing apparatus 1 shown in FIG. 1.

The pressurizing part 11 is not limited in particular if being able to pressurize water of the pressure-receiving part 10. For example, one end of the pressurizing part 11 attaches to the opening part 10a upper the pressure-receiving part 10 in a coherence state, and another end of the pressurizing part 11 has a pressuring area being wider than the opening area of the opening part 10a of the pressure-receiving part 10. The pressurizing part 11 includes a piston part 11a, a supporting part 11b, and a pressure-controlling part 11c. The piston part 11a is able to move to inner and outer direction (top and bottom direction) of the pressure-receiving part 10. The supporting part 11b is for supporting and fixing the other end of the piston part 11a. The pressure-controlling part 11c is for applying pressure to the pressure-receiving part 10 by pushing up the bottom face of the pressure-receiving part 10, the bottom face being able to move to top and bottom direction. The inner direction is corresponding to the pressurization direction, and the outer direction is corresponding to the de pressurization direction.

The piston part 11a functions as a cover part for the opening part 10a of the pressure-receiving part 10, and the pressure-receiving part 10 is able to move to inner and outer direction. Therefore, when the pressure-controlling part 11c pushes up the bottom face of the pressure-receiving part 10, the opening part 10a of the pressure-receiving part 10 attaches to the piston part 11a, and the piston part 11a pressurizes water in the pressure-receiving part 10.

The pressure applied by one end of the piston part 11a is amplified easily at the multiplying factor divided the pressurization area of the other end of the piston part 11a by the opening area of the one end of the piston part 11a. Therefore, when the one end of the piston part 11a is touched to water in the pressure-receiving part 10 and the piston part 11a is pressurized by the movement to the inner direction of the pressure-receiving part 10, it is possible to easily apply super high hydrostatic pressure processing to brown rice in the water.

Here, the piston part 11a of the pressurizing part 11 is corresponding to the opening part 10a of the pressure-receiving part 10, and includes a seal material (packing material) sealing the movement face for the pressure-receiving part 10. Therefore, it is possible to properly apply high hydrostatic pressure to brown rice in the water. The pressure-controlling part 11c is not limited in particular, for example, the pressure-controlling part 11c composites of a hydraulic cylinder, and includes a pressurization aspect 11c1, pressurized liquid 11c2 (e.g., oil), and a liquid-supplying part 11c3. The pressurization aspect 11c1 contacts with the pressure-receiving part 10, and is able to move to the inner and outer direction. The pressurized liquid 11c2 contacts with the pressurization aspect 11c1, and is filled the inside of the pressure-controlling part 11c. The liquid-supplying part 11c3 controls to pressurize to the pressurization aspect 11c1 by increasing and decreasing the pressurized liquid 11c2. Therefore, it is possible to form super high hydrostatic pressure easily without using the special apparatus.

The composition between the supporting part 11b and the other end of the piston part 11a is not limited in particular if the both are contacted directly. Or a predetermined supporting board 11b1 (top of table) is provided among the both. The outer peripheral surface of the pressure-receiving part 10 is not limited in particular if being provided a constant temperature part (not illustrated) maintaining water temperature of the inside of the pressure-receiving part 10 to predetermined temperature. The constant temperature part is arranged on the outer peripheral surface of the pressure-receiving part 10, and includes a pipe part and a cycle part. Water circulates the inside of the pipe part. The cycle part controls flow quantity (or speed) of the water circulated in the pipe part. Therefore, it is possible to maintain water temperature to desired temperature when applying high hydrostatic pressure to brown rice. The constant temperature part may adopt a means to heat and cool with electricity.

The manufacturing apparatus 1 may include a fermenting part (fermenting means) for increasing the content of free ferulic acid in the fermented food by fermenting the processed brown rice with using yeast, or by pregelatinizing the processed brown rice and then fermenting the same with using yeast.

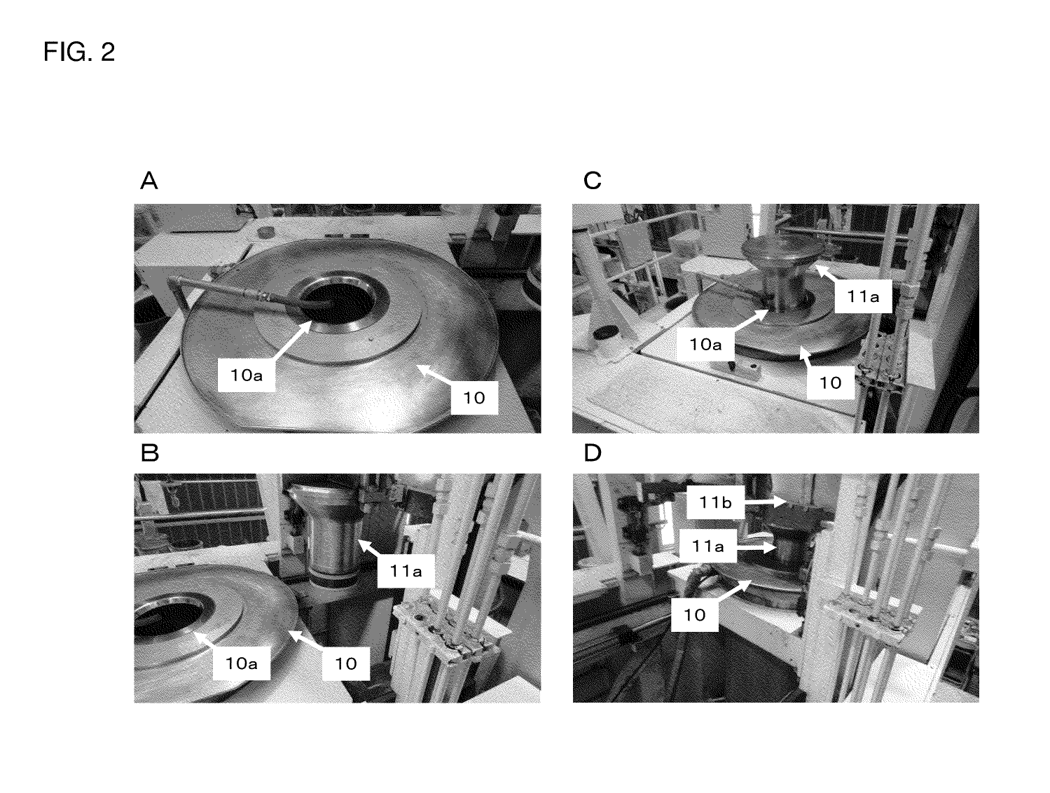

The manufacturing method of the present invention is explained in detail by using the manufacturing apparatus 1 shown in FIG. 1. At first, as shown in FIG. 2A, a manufacturer puts brown rice B of a predetermined quantity in the housing part 10b through the opening part 10a of the pressure-receiving part 10 and puts water W with a hose until the brown rice B is immersed in the water. For example, as shown in FIG. 1B, the manufacturer puts brown rice B of a predetermined quantity and water W of a predetermined quantity in a pressure tightness bag, and puts the bag in the housing part 10b. Therefore, it is possible to keep water W penetrated to the brown rice B clean water, the clean water not contacting with the inner wall of the housing part 10b. When the manufacturer puts water W in the housing part 10b after putting the bag, it is preferable to remove air in the housing part 10b by full water W in the housing part 10b.

Next, as shown in FIG. 2B, the manufacturer makes the piston part 11a moved to the upper of the opening part 10a with a predetermined moving means. As shown in FIG. 2C, the manufacturer makes the piston part 11a attached the opening part 10a. At that time, the bottom (undersurface, pressurization face) of the piston part 11a contacts to water surface (the most top surface) of the water in the pressure-receiving part 10. The water temperature in the pressure-receiving part 10 is in 0.degree. C. to 35.degree. C.

As shown in FIG. 2D, the manufacturer makes the pressure-receiving part 10 which is attached the piston part 11a moved to lower of the supporting part 11b of the pressurizing part 11 with a predetermined moving means, and makes the supporting part 11b and the other end of the piston part 11a contacted mutually. And, the manufacturer drives the pressure-controlling part 11c with a predetermined operating means, pushes the bottom of the pressure-receiving part 10 up, makes the pressure of the pressure-receiving part 10 amplified by the constitution of the piston part 11a, and makes the brown rice in water applied hydrostatic pressure of 100 MPa to 600 MPa. The manufacturer decides hydrostatic pressure (e.g., 600 MPa) of the aim beforehand, and applies the hydrostatic pressure until the normal hydrostatic pressure (0.1 MPa) of the brown rice in water reaches to the hydrostatic pressure of the aim.

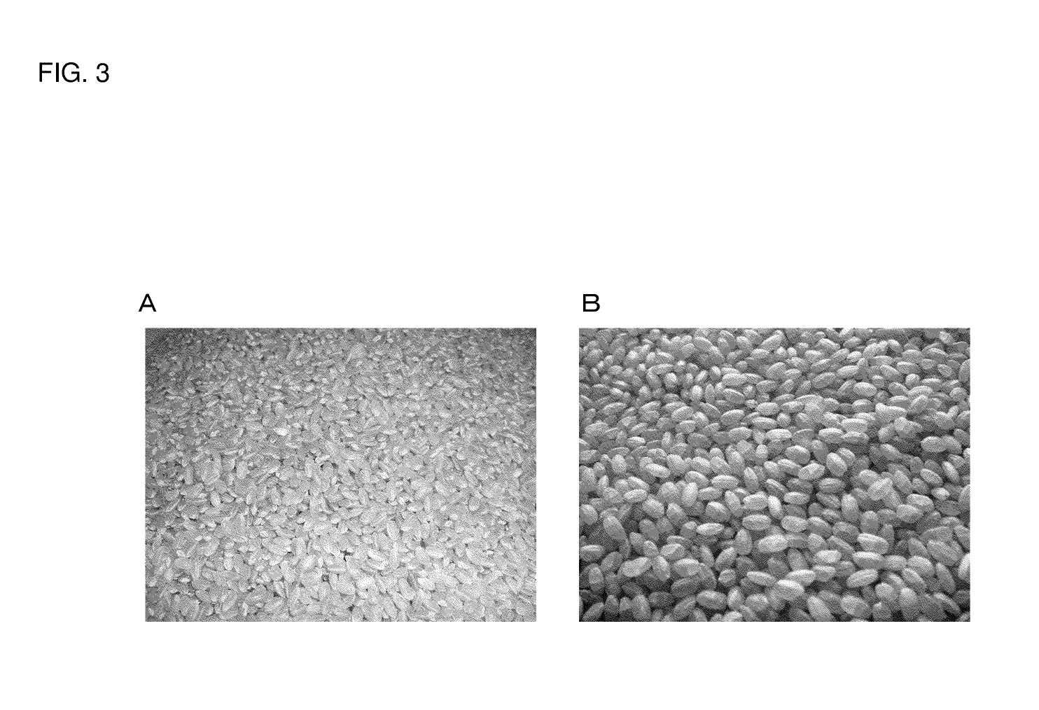

When the hydrostatic pressure applied to the brown rice reaches to the hydrostatic pressure of the aim, the manufacturer releases the pressurization of the piston part 11a, the hydrostatic pressure of the brown rice becomes low hydrostatic pressure from the hydrostatic pressure of the aim, and returns normal pressure. At that time, if predetermined pressurization time may be provided, pressurizing and depressurizing processing of the hydrostatic pressure in 100 MPa to 600 MPa may be repeated. And, the manufacturer detaches the pressure-receiving part 10 from the supporting part 11b, and puts out the piston part 11a from the opening part 10a. When the manufacturer takes out internal brown rice B and dries the brown rice B immediately with the drying part, the processed brown rice is produced. By applying hydrostatic pressure (e.g., 600 MPa) to brown rice shown in FIG. 3A, the processed brown rice shown in FIG. 3B is manufactured, and the processed brown rice includes free ferulic acid in large quantities.

### EXAMPLES, COMPARATIVE EXAMPLES, ETC.

The present invention will be explained below according to examples, comparative examples, etc., and do not limit by there.

### Example 1, Comparative Example 1

The processed brown rice of Examples 1 was manufactured by applying hydrostatic pressure of 100 MPa, 200 MPa, and 600 MPa to each brown rice (Koshihikari brown rice made in Japan) in water at ordinary temperature to thereby dry the later processed brown rice immediately at ordinary temperature and normal pressure after the application of the hydrostatic pressure with the manufacturing apparatus 1 shown in FIG. 1 and the manufacturing method shown in FIG. 2. The processed brown rice was manufactured three times on the different date and time (summer, winter). The water temperature before applying the hydrostatic pressure was in 0.degree. C. to 35.degree. C., the pressurization time was in 1 second to 30 seconds, and the pressurization speed and depressurization speed were in 3 MPa/sec to 200 MPa/sec. A brown rice without the pressurization was Comparative example 1.

### Evaluating Method

The content of free ferulic acid and total ferulic acid in Example 1 and Comparative example 1 was measured by general foundational juridical person food analysis development center SUNATEC in Minister of Health, Labour and Welfare Registered Inspection Body. Here, the measurement of the content of free ferulic acid was as follows. The analytical instrument was a high performance liquid chromatography (made in Nipon Bunkou Co., Ltd.), the analysis column was a Mightysil RP-18 GP 150-4.6 (5 μm), the column temperature was 40 .degree. C., and the detector was UV (320 nm) (AUX Range 4). The eluate consisted of A liquid of 10% methanol (includes 0.1% TFA) and B liquid of 100% methanol (includes 0.1% TFA), the eluate at start time consisted of 100% A liquid and 0% B liquid, and the eluate after 35 minutes consisted of 0% A liquid and 100% B liquid. The flow speed was 1.0 mL/min, the injection volume of sample was 20 μL, and the adjusted sample was the solution diluted a sample to 5 times with A liquid. The measurement of the content of total ferulic acid was by applying the alkali processing (pre-processing) with the sodium hydroxide aqueous solution to a sample, and by measuring the content of total ferulic acid of the sample with a high performance liquid chromatography.

### Evaluating Result

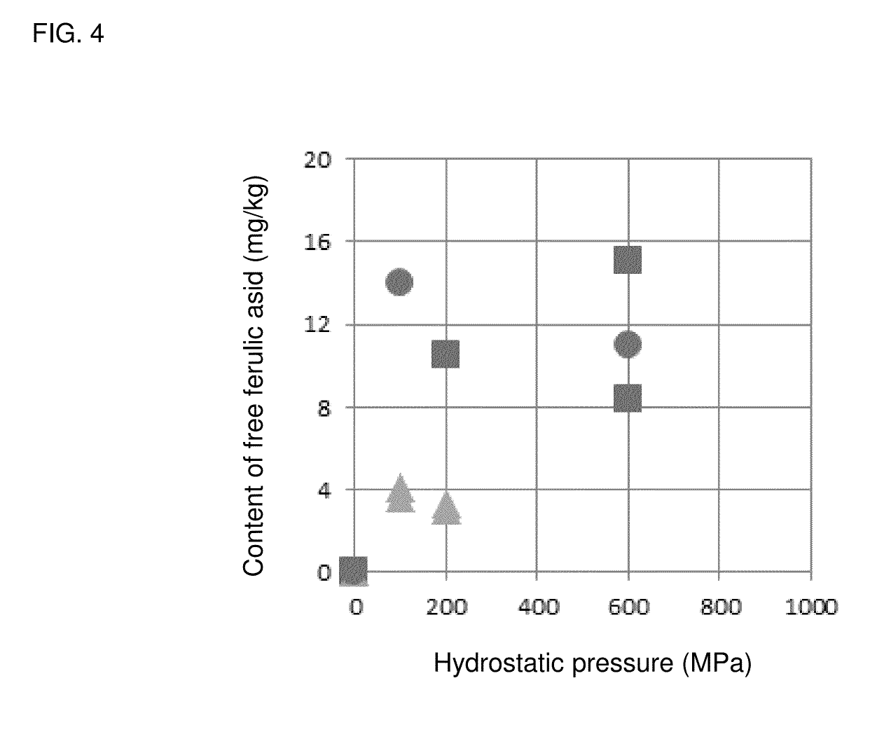

As shown in FIG. 4, the content of free ferulic acid in the brown rice of Comparative example 1 was 0.0 mg/kg (below the detection limit), and the content of free ferulic acid in the processed brown rice of Example 1 was in the range of 3 mg/kg to 15 mg/kg linearly or logarithmically as the hydrostatic pressure increased. When the processed brown rice of Example 1 was manufactured on the different date and time, the tendency of the increase in the content of free ferulic acid with an increase in the hydrostatic pressure was represented. The content of total ferulic acid in the brown rice of Comparative example 1 was 320 mg/kg, and the content of total ferulic acid in the processed brown rice of Example 1 at 100 MPa and 600 MPa was 270 mg/kg. Therefore, by applying the hydrostatic pressure to brown rice, it is possible to increase the content of free ferulic acid in comparison with normal brown rice. By water immersion of the brown rice under super high hydrostatic pressure, the content of total ferulic acid was not increased, and the enzymes in the brown rice had no activities.

<fermented food with using the processed brown rice as raw material>

### Example 2, Comparative Example 2, 3, Evaluating Method

Sliced bread was manufactured by adding hard flour, water, milk, sugar, salt, yeast (yeast fungus), and butter to rice boiled with red beans appropriately, the rice boiled with red beans boiled with using the processed brown rice applied the hydrostatic pressure of 600 MPa in Example 1 and red beans (made in Hokkaido) with the above method, by primary-fermenting and second-fermenting, by making bread dough, and by burning with an oven. And bagel, panettone, stollen were manufactured by using the boiled processed brown rice in Example 1, and these bread were Example 2. The bread manufactured by the same as the manufacturing method of Example 2 with using normal wheat flour and without using the processed brown rice was Comparative example 2. The bread manufactured by the manufacturing method like the same as the manufacturing method of Example 2 with using normal brown rice was Comparative example 3. The measurement of the content of free ferulic acid in Example 2, Comparative example 2, 3 was the same as the above-described measurement.

### Evaluating Result

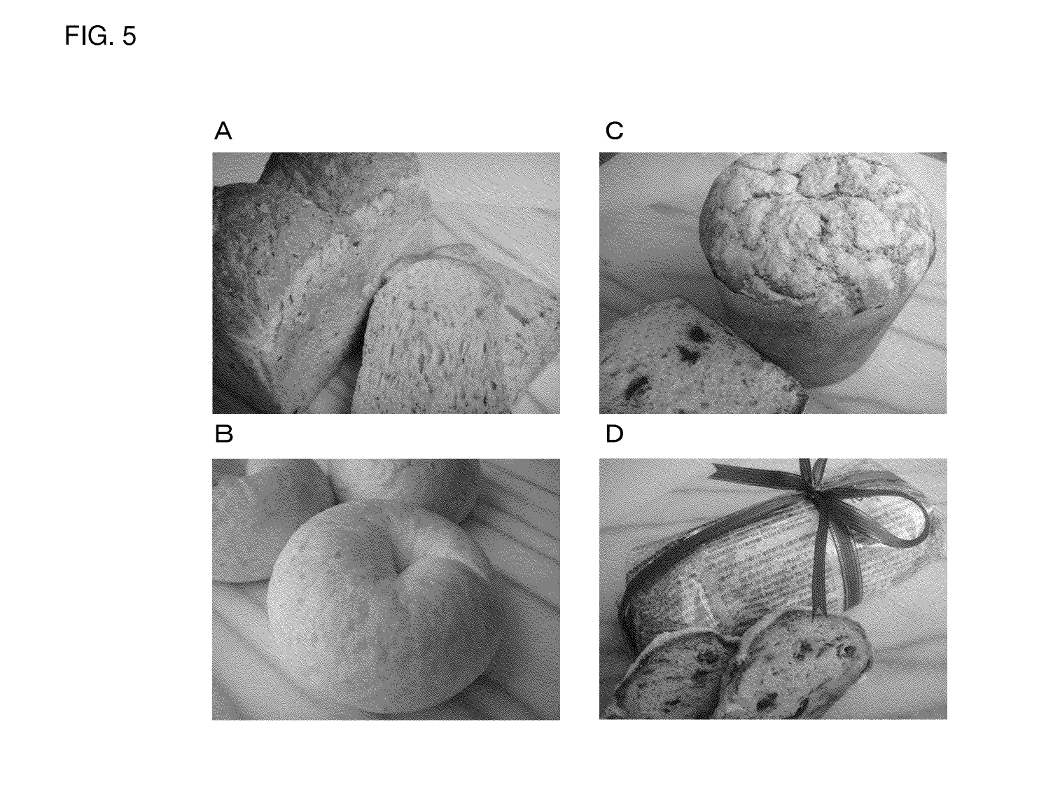

As shown in FIG. 5A, FIG. 5B, FIG. 5C, FIG. 5D, the sliced bread, the bagel, the panettone, the stollen were good looking. The content of free ferulic acid in Comparative example 2, 3 was 0.0 mg/kg, and the content of free ferulic acid in Example 2 was 2.5 mg/kg. The food feeling of the bread in Example 2 was springy and softly, and the bread was delicious. Therefore, it is possible to increase the content of free ferulic acid by manufacturing fermented food with boiling the processed brown rice.

### Example 3, 4, Comparative Example 4-6, Evaluating Method

Sake was manufactured by doing the step koji production, sake mash-making, and sake brewing preparation including the fermentation processing of yeast, with using the processed brown rice applied the hydrostatic pressure of 600 MPa in Example 1 as steamed rice with using the above-described method. The sake was Example 3. The sake lees obtained by manufacturing the sake in Example 3 were Example 4. Normal brown rice was entered to rice-polishing machine to cut the fat and the protein of the outer layer, and the normal brown rice became polished rice. With using the polished rice as steamed rice, sake was manufactured by doing the step koji production, sake mash-making, and sake brewing preparation with the same as the manufacturing method of Example 3. The sake was Comparative example 4. The sake lees obtained by manufacturing the sake in Comparative example 4 were Comparative example 5. With using the brown rice before applying the pressurization, sake was manufactured by doing the step koji production, sake mash-making, and sake brewing preparation with the same as the manufacturing method of Example 3. The sake was normal brown rice sake, and the normal brown rice sake was Comparative example 6. The measurement of the content of free ferulic acid in Example 3, 4, Comparative example 4-6 was the same as the above-described measurement. The alcohol concentration was measured by the general foundational juridical person food analysis development center SUNATEC, and was done by a well-known method.

### Evaluating Result

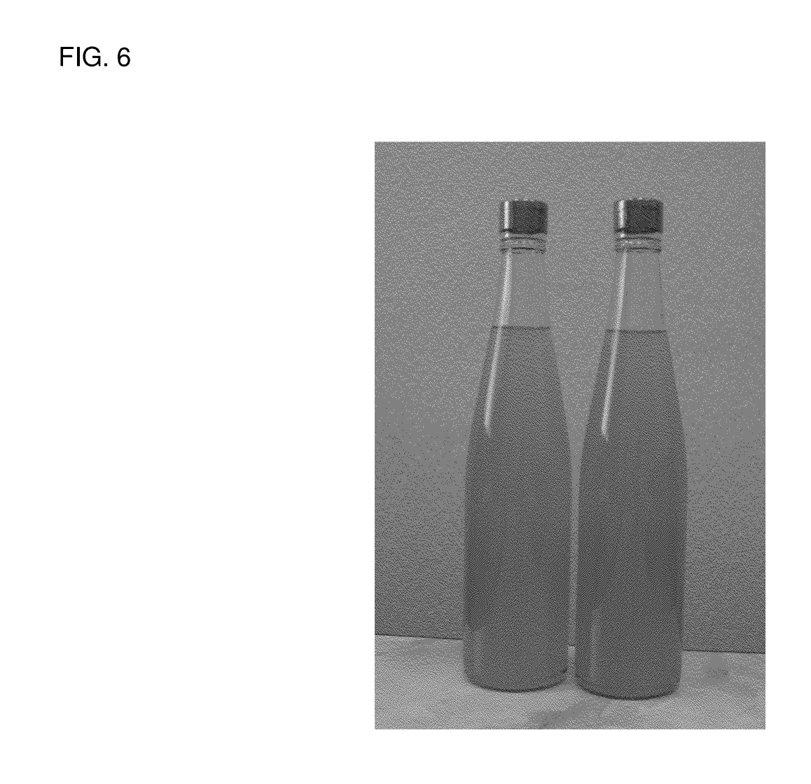

As shown in FIG. 6, the sake in example 3 by using the processed brown rice as steamed rice was a slightly yellow-tinged color. The content of free ferulic acid in the sake of Comparative example 4 was 2.6 mg/kg, and the content of free ferulic acid in the sake of Example 3 is 18.9 mg/kg. The content of free ferulic acid in the sake lees of Comparative example 5 was 1.6 mg/kg, and the content of free ferulic acid in the sake lees of Example 4 was 68.2 mg/kg. The content of free ferulic acid in the brown rice sake of Comparative example 6 was 0.0 mg/kg. Therefore, it is possible to increase the content of free ferulic acid by manufacturing fermented food with steaming the processed brown rice. The alcohol concentration in the sake of Comparative example 4 was 14 degrees, and the alcohol concentration in the sake of Example 3 was 17 degrees.

### INDUSTRIAL APPLICABILITY

As described above, processed brown rice, fermented food, and a method for manufacturing processed brown rice are useful as tools of food field, medical field, pharmacy field, and the like. It is effective as processed brown rice, fermented food, and a method for manufacturing processed brown rice which can increase the content of free ferulic acid contributing to the amelioration of dementia, and the like.

### REFERENCE SIGNS LIST

1 Manufacturing apparatus

10 Pressure-receiving part

11 Pressurizing part

1-3. (canceled)

4. High hydrostatic pressure-applied processed brown rice being obtained by a method comprising:
applying hydrostatic pressure of 100 MPa to 600 MPa to brown rice in water at 0 degrees C. to 35 degrees C. to thereby increase the content of free ferulic acid in the brown rice, and
drying the brown rice immediately after the application of the hydrostatic pressure.

5. Fermented food such as bread, sake or sake lees that is manufactured by using processed brown rice as raw material, the processed brown rice being obtained by a method comprising:
applying hydrostatic pressure of 100 MPa to 600 MPa to brown rice in water at 0 degrees C. to 35 degrees C. to thereby increase the content of free ferulic acid in the brown rice, and
drying the brown rice after the application of the hydrostatic pressure, the fermented food increasing the content of free ferulic acid in the fermented food by fermenting the processed brown rice by one of using yeast or by pregelatinizing the processed brown rice and then fermenting the same with using yeast.

6. A method for manufacturing high hydrostatic pressure-applied processed brown rice, the method comprising:
a step of putting brown rice in water at 0 degrees C. to 35 degrees C.,
a step of applying hydrostatic pressure of 100 MPa to 600 MPa to the brown rice to thereby increase the content of free ferulic acid in the brown rice, and
a step of drying the brown rice immediately after the application of the hydrostatic pressure.
